(19) United States
(12) Patent Application Publication
(10) Pub. No.: US 2010/0127981 A1
(43) Pub. Date: May 27, 2010

(54) METHOD FOR THE SITUATION-ADAPTED DOCUMENTATION OF STRUCTURED DATA

(76) Inventors: Alexander U. Brandt, Berlin (DE); Christoph Hornung, Berlin (DE); Sebastian Mansow-Model, Berlin (DE)

Correspondence Address: SMYRSKI LAW GROUP, A PROFESSIONAL CORPORATION, 3310 AIRPORT AVENUE, SW, SANTA MONICA, CA, 90405, US

(21) Appl. No.: 12/452,851

(22) PCT Filed: Jul. 24, 2008
(86) PCT No.: PCT/DE2008/001244

§ 371 Date: Jan. 22, 2010

(30) Foreign Application Priority Data
Jul. 24, 2007 (DE) 102007034852.7

(51) Int. Cl. G06F 3/033; G09G 5/00; G06F 3/02

(52) U.S. Cl. 345/163; 345/156; 345/168

(57) ABSTRACT

This invention describes a method for providing a subsequently revised input form, in which a prediction system selects at least one input form out of a number of input forms and displays them for the user to select.

Computer systems are an important part of data acquisition by humans. On the one hand computerized data acquisition is used for documentation and storage; on the other hand further processing of the collected data is essential. If this processing is to be done completely and automatically by computer systems, it is vital to acquire data while conserving semantic meaning.

For this, computer systems usually use highly structured input forms with embedded semantic information. This approach reaches its limits when applied to complex and heavily variable fields like e.g. medicine. To be able to use semantic forms in these fields, current systems are either based on tree view selection masks to find relevant forms, or on concatenated entry masks. Nevertheless, the complexity of data in these fields regularly exceeds the capacity of classic form approaches:

If the masks get too extensive, the user has to spend an considerable amount of time to find the specific entry mask or position for the next data entry. On the other hand, if the forms are kept simple and user-friendly, important detail information is lost or the mask is completely insufficient for a special case.

Furthermore, such an entry system cannot automatically consider individual preferences of different users. For this purpose, the system and its forms have to be customized to different needs with considerable resources of time and expert knowledge.

Because of these issues, computerized documentation has to be done with loss of semantic information in many applications, using—for example—unstructured, narrative free texts. These data are not entirely process-able by computer systems and/or have to be interpreted manually with considerable effort.

In summary this leads to ineffective work flows with extensive loss of time, since full computer automation is not available or very limited.

### DESCRIPTION

The aim of this invention is to provide an immediate and fast documentation of all data while upholding its semantic information.

The invention refers to a method that, depending on a given situation and using methods of machine learning, predicts following documentation steps. A system of software implemented agents adapts predictions to requirements and preferences of persons or entities directly or indirectly involved in the documentation process. This information is then used to adapt a user interface, incorporating semantic information such as the entering person has faster access to relevant components in every situation.

### Modules

The system uses entry form or mask components that are referred to as Modules in the following.

These Modules may contain single entry components.

These Modules may represent a data structure including semantic information.

These Modules may represent simple or complex documentation scenarios.

These Modules may consist of system-internal or external masks.

These Modules may be intended for data entry.

These Modules may be intended for data visualization.

These Modules may contain elements that trigger procedural command chains.

### Entry Situation

The system uses an Entry Situation that may represent a collection of Modules already filled in by the user.

The Modules may be described by their corresponding resulting data.

In the Entry Situation the order of already filled in Modules may be considered.

In the Entry Situation the time of usage may be considered.

In the Entry Situation the place of usage may be considered.

In the Entry Situation the identity of participating persons and instances or the data resulting thereof may be considered.

### Prediction System

A Prediction System determines a prediction set V={vᵢ}, i=0, . . . , n with vᵢεX=(M,R) based on the Entry Situation, where M is the set of Modules and R is the computed relevance of a Module.

The Prediction System may store data that is relevant to predictions in a data store.

The Prediction System may process Entry Situations time-delayed to the entry execution by processing Module data stored in the data store.

The Prediction System may evaluate all possible Entry Situations to adjust its decision algorithm or store data as a basis for decision making.

The decision algorithm of the Prediction System may use a single or a combination of the following mechanisms:
Specifications that may be defined as a meta language
Methods of machine learning which may contain:
   Association analysis
   Neural networks
   Decision trees
   Bayesian networks
   Decision networks
   Inductive logical programming
   Heuristic algorithms

The decision algorithm may consider data semantic of Modules and their data structures.

### Agent System

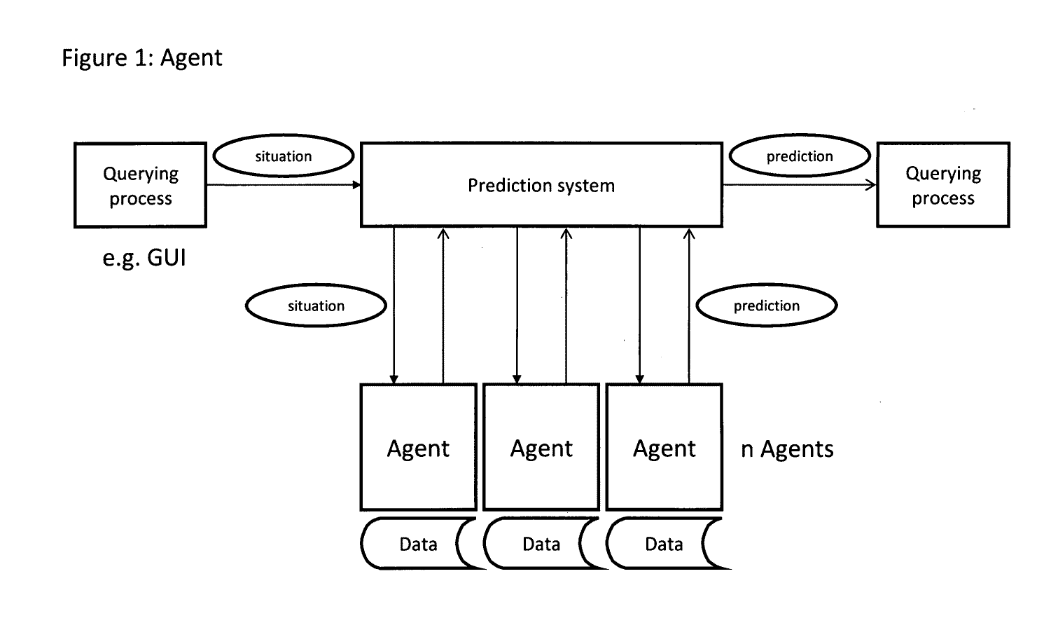

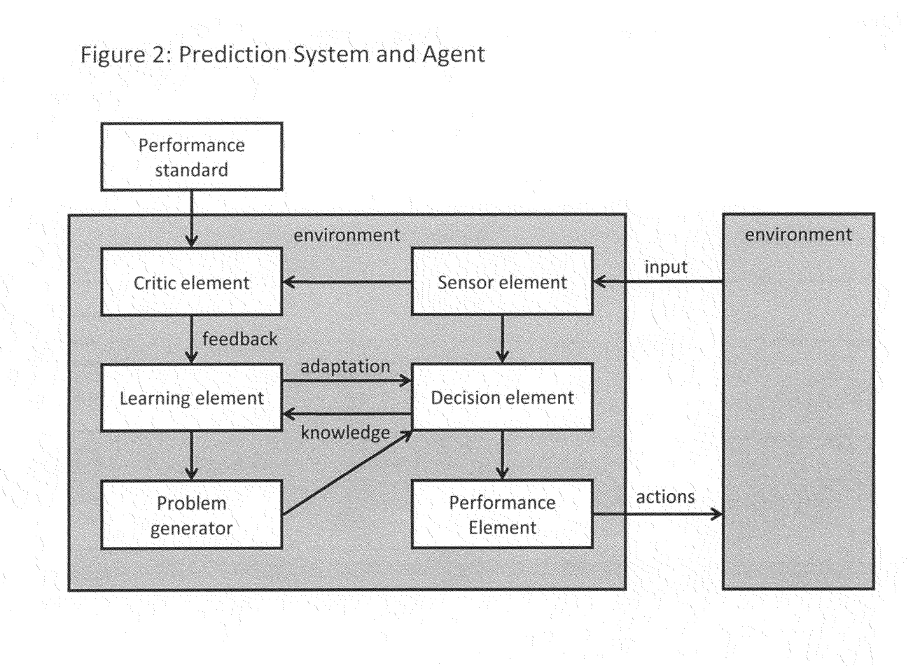

The Prediction System may delegate the situation analysis to Agents (FIGS. 1 and 2). The Prediction System may use the same strategies for analysis and integration of the predictions of Agents as for its own predictions.

An Agent System may consist of arbitrary many Agents.

The inclusion of an Agent by the Prediction System may be dependent on the Entry Situation.

An Agent may represent the interests and requirements of a person or institution concerning the documentation process.

Based on the Entry Situation, an Agent determines the prediction set V={vᵢ}, with vᵢεX=(M,R), where M is the set of Modules and

R is the computed relevance of a Module. Every Agent may use the same methods as the Prediction System to generate its prediction.

The predictions of all Agents are transferred back to the Prediction System. The Prediction System aggregates all prediction sets Vᵢ=(m_{i,j},r_{i,j}) with j=1, . . . , n into a single prediction V=(mⱼ,rⱼ) with i−1, . . . , n where the relevance rⱼ results from the relevance of the predictions of Agents r_{i,j}. Additionally, the Agent prediction may be weighted to modify their impact on relevance rⱼ.

The weighting of an Agent by the Prediction System may be computed by a learning algorithm. Here, every prediction made by an Agent caused by a change of the Entry Situation may be compared to the prediction success to increase weighting of specific Agents with more than average correct predictions, or decrease weighting of Agents with less than average predictions.

The aggregated prediction is then transferred back to the querying process, usually a graphical user interface (GUI).

### Graphical User Interface

In a graphical user interface (GUI), a user can interact with Modules and, for example, enter and/or evaluate data. Modification of Module content by the user can lead to a new Entry Situation.

As soon as a new Entry Situation arises, it can be send to the Prediction System, and a prediction can be made by the Prediction System for use of further Modules.

Depending on this prediction, suitable Modules can be presented in such a way, that the user can select increasingly relevant modules with decreasing effort.

The Prediction System, as well as the respective Agents, can determine the quality of a prediction from the successively generated and sent Entry Situations.

### Example for an Implementation

The following example describes a possible implementation for use in medical documentation.

### Module

Individual medical statements are modeled using XML schema, and a data model is designed which can store data about every fact in an XML structure. Semantic information provided by a medical nomenclature (e.g. SNOMED CT) is added within the structure.

XSLT definitions are provided for flexible display of data. A visual component is defined using XAML (Microsoft WPF) for use of the module at the client-side (GUI). A code generator connects XML data model with XAML visual components programmatically. Live transfer of data and modules take place via web services.

In this example, the following modules, among others, were defined, each of which represents the individual components in the framework of a colonoscopy.

TABLE 1
SELECTION OF RELEVANT MODULES IN THIS EXAMPLE

| MODULE | DESCRIPTION |
|---|---|
| intestinal polyp | Documentation module for finding of an intestinal |
| | polyp within a colonoscopy. It documents, among |
| | others, size, consistency of surface, quantity and |
| | localization. |
| polypectomy | Documentation module for removal of an intestinal |
| | polyp. It documents, among others, form of |
| | removal, therapeutic success and recovery of |
| | removed tissue. |
| chromoendoscopy | Documentation module for usage of diagnostic |
| | chromoendoscopy. It documents, among others, used |
| | dye and dye enhancement on applied tissue |
| biopsy | Documentation module for a biopsy. It documents, |
| | among others, type of biopsy, localization and |
| | questions for a pathologist. |
| QA intestinal | Documentation module for quality assurance. |
| polyp | |
| polyposis | Documentation module for polyposis syndrome |
| syndrome | diagnosis. |

### Entry Situation

The client forwards the current entry situation to the prediction system via a web service. The entry situation comprises the currently used module “intestinal polyp”, including its data, as well as the identification number of the user (Dr. Meier) and patient data (John Doe, born Jan. 1, 1965) such as size, gender, etc.

### Prediction System

The prediction system consults subordinate agents to generate the prediction. It determines which agents to consult on the basis of information contained in the entry situation: the user's agent, his superior's agent, the treated patient's agent, the medical controller's agent. The entry situation is transmitted to all of the aforementioned agents.

### Agent System

Each agent makes a prediction based on its data pool and algorithms, and transmits it back to the prediction system. By means of an association analysis of its data store, the User Agent determines the relevance for the user of further modules in the entry situation. Since Dr. Meier has not worked with the system yet, this agent cannot make any predictions in this example.

TABLE 2
AGENT LIST

| AGENT | DESCRIPTION |
|---|---|
| Patient | Specific agent of current patient John Doe. |
| | With previous documentation of the patient's |
| | encounters, this agent has learned the encounter |
| | path via an association analysis. Among others, |
| | information about about a polyposis syndrome |
| | diagnosis is contained. |
| | This agent learns, whenever patient John Doe's |
| | encounters are documented. |
| User | Specific agent of physician Dr. Meier. |
| | Mr. Meier is new in the department. This |
| | documentation process is his first entry in the |
| | system. |
| | The agent learns when Dr. Meier enters data |
| | himself. |
| Head Physician | Specific agent of head physician Dr. Mueller. |
| | Dr. Mueller has worked with the system for many |
| | months. His agent has integrated Dr. Mueller's |
| | specific requirements and usage scenarios via an |
| | association analysis and a artificial neural |
| | network using the study documentation already |
| | entered by him. |
| | This agent learns when Dr. Mueller personally |
| | enters data. |
| Medical | Common agent of medical controlling in the |
| controller | hospital. |
| | Fixed specifications about documentation paths and |
| | requirements are provided in the agent using an |
| | XML-based meta language. Thereby defining, among |
| | others, that during documentation of an intestinal |
| | polyp, the documentation module “QA intestinal |
| | polyp” has to be completed. |
| | This common agent does not learn since the medical |
| | controlling never takes part in data entry |
| | directly. |
| System agent | Common system agent |
| | This agent was configured with aggregated |
| | information from previous documentation processes. |
| | It incorporates an aggregation of the relevant |
| | documentation steps by means of an association |
| | analysis and an artificial neural network. |
| | Additionally, fixed guidelines are included |
| | specifying which module combinations are possible |
| | and which are not. For example, it is ruled out, |
| | that a “polypectomy” module can be followed by a |
| | subordinate “chromoendoscopy” module. |
| | This agent does not learn. However, it is possible |
| | to further develop the learning algorithm and its |
| | data pool through specific system maintenance. |

The head physician's agent proceeds accordingly and computes its prediction: In consideration of the information from “Size of the intestinal polyp” it allocates a relevance of 0.8 for a “chromoendoscopy”, 0.1 for “biopsy” and 0.1 for “polypectomy”.

The prediction of the medical controller's agent indicates that module “QA intestinal polyp” has to be filled out.

The patient's agent integrates the modules for “polyposis syndrome” based on an association analysis and a neural network algorithm and its data store.

### Feedback to the Prediction System

The consulted agents send their predictions back to the prediction system. This integrates the individual predictions considering the weighting of the individual agents by means of a neural network.

### Transfer to the Client GUI

The integrated prediction is transmitted to the requester system, a GUI client. The client evaluates the prediction and adjusts its interfaces, by means of the transmitted modules, to their relevance and the additional information contained. Possible further documentation modules are displayed differently based on their relevance for the further process:
The module with highest relevance is placed directly at the nearest documentation position. (“Chromoendoscopy”)
The two modules with the nearest lower relevance are displayed below minimized. (“Polypectomy”, “Biopsy”)
Modules whose relevance is low are displayed in the command bar of the GUI ordered by their semantic information. (“Polyposis syndrome”)
Modules that were not included in the prediction can be found by a search function with semantic support.
Compulsory modules are highlighted in a different color. (“QA intestinal polyp”)

The user finds required user interface elements immediately, and carries on with the documentation.

### Feedback and Learning

The next entry situation is analyzed for adjustment of gents and their weighting and is sent to each agent as feedback.

In this example, Dr. Meier has decided to document a biopsy. Via feedback, his agent is trained and thus later predictions for Dr. Meier modulated. Additionally, patient John Doe's agent integrates the feedback. Since owners of all other agents are only indirectly involved in the current documentation, they do not learn.

Upon Dr. Meier's next entry, the prediction system will calculate the documentation of a biopsy with a higher probability.

### GLOSSARY AND LEGEND FIG. 1

### Performance Standard

Fixed weighting criteria for a situation in an environment.

### Sensor Element

Observes processes/the situation in the environment and redirects them as impressions.

### Decision Element

Decides in favor of an action based on the impressions received.

### Performance Element

Executes an action proposed by the decision element.

### Critic Element

Supplies feedback about how successfully the agent behaves.

### Learning Element

Decides how the decision element should be adjusted, based on the feedback of the critique element, in order to make decisions more successfully.

### Problem Generator

Generates proposals of actions that procure new and informative experiences, without pretension to be instantaneously optimum.

1. Method to allocate a subsequently editable input form, in which a prediction system chooses one input form out of many input forms and displays at least one input form to the user.

2. Method according to claim 1, thereby characterized, that the prediction system considers data previously entered by the user for selection of predicted input forms presented to the user.

3. Method according to claim 2, thereby characterized, that the prediction system considers additional data stored in a database in calculating its prediction.

4. Method according to claim 1, thereby characterized, that additionally to provided input forms, links to computer programs are displayed for selection, which are chosen from a database using data provided by the user and/or information stored in the data base.

5. Method according to claim 4, thereby characterized, that the provided input forms and/or programs are displayed in a selection user interface and the user can, especially through keyboard or mouse input, get access to the selected input form and/or program by selecting items.

6. Method according to claim 4, thereby characterized, that the prediction system assigns a probability value to each provided information, input form or program.

7. Method according to claim 6, thereby characterized, that provided data, especially information, input forms or programs is ordered for selection by the user in a user interface or dialog according to the dedicated probability value and/or that the probability value is displayed within the user interface.

8. Method according to claim 6, claims, thereby characterized, that the probability value indicates, how probable it was at least in the past, that specifically provided data in the form of labels of the particular input forms were selected by the user in the next user interaction.

9. Method according to claim 2, thereby characterized, that the prediction system is an adaptive system, which adapts its knowledge base using the data selection and interaction from the user.

10. Method according to claim 1, thereby characterized, that the prediction system has sub programs and/or agents with autonomic consideration of at least one decision criterion.

11. Method according to claim 10, thereby characterized, that the sub programs and/or agents each calculate a selection of provided input forms and send this selection or selection list to the prediction system.

12. Method according to claim 11, thereby characterized, that the sub programs and/or agents allocate at least one probability value and/or one weighting to the selection or selection list to be sent to the prediction system.

13. Method according to claim 10, one of the claim 10, 11 or 12, thereby characterized, that a weighing factor is allocated to every subprogram or agent.

14. Method according to claim 10, thereby characterized, that the prediction system displays the input forms provided by subprograms and/or agents, either unfiltered or evaluated and filtered for selection by the user.

15. Method according to claim 14, thereby characterized, that the prediction system arranges the input masks provided by the subprograms and/or agents, by means of the probability values and/or weighing factors allocated by the subprograms and/or agents, and provide them to the user for selection.

16. Method according to claim 15, thereby characterized, that the prediction system additionally takes into account the weighing factors of the subprograms and/or agents for the calculation of the input masks to be shown to the user for selection.

17. Method according to claim 10, thereby characterized, that the method supports the input of medical data in the sense that additional input forms for entry of further data are preselected and displayed for the person who enters the data, at which point the person can choose the input mask from the displayed selection.

18. Method according to claim 10, thereby characterized, that the prediction system initiates agents and/or subprograms by means of the data already existing in the database, so that they identify from among the existing input forms the most probable input form needed for entry of further data, during which the prediction system filters the input forms detected by the subprograms and agents and shows them to the user either immediately or upon request.

19. Method according to claim 10, thereby characterized, that the prediction system carries out an analysis of the “is” situation on the basis of the selection performed by the user, and delivers it to the subprograms and agents, and these carry out an adaptation of their search and decision algorithm based on the data provided.

20. Method according to claim 1, thereby characterized, that the input forms made available for selection are adapted by the prediction system to the respective input forms, based on actual inputs performed in the past.

21. Method according to claim 3, thereby characterized, that the quality of the prediction is supervised by the prediction system, and an ongoing adaptation is performed by the system based on the evaluated quality.

22. Method according to claim 1, thereby characterized, that the effort required for the input of data using the respective input form is displayed to the user before selecting it.
